(19) United States
(12) Patent Application Publication
(10) Pub. No.: US 2014/0132723 A1
(43) Pub. Date: May 15, 2014

(54) METHODS FOR CALIBRATING A DIGITAL PHOTOGRAPHIC IMAGE OF UTILITY STRUCTURES

(71) Applicant: OSMOSE UTILITIES SERVICES, INC., Buffalo, NY (US)

(72) Inventor: Randal K. More, LaFayette, NY (US)

(21) Appl. No.: 13/828,020

(22) Filed: Mar. 14, 2013

Related U.S. Application Data
(60) Provisional application No. 61/725,748, filed on Nov. 13, 2012.

(51) Int. Cl. H04N 13/02

(52) U.S. Cl. CPC H04N 13/0246
USPC 348/46

(57) ABSTRACT

The present invention relates to methods of performing precise measurements of utility poles, utility-pole attachments and connected spans for the purpose of load analysis, safety analysis, and related tasks using low density sparse LiDAR data to pre-compute the matrices required to perform precise photogrammetric analysis of utility poles, utility-pole attachments and connected spans as imaged by a camera with a known spatial geometry relative to a LiDAR sensor.

### TECHNICAL FIELD OF INVENTION

The present invention relates to methods of photogrammetric analysis of utility poles, utility-pole attachments and connected spans of a digital photographic image calibrated using low-density, sparse LiDAR data.

### BACKGROUND OF THE INVENTION

Wood poles and aerial plant supported America's first communications revolution more than one hundred years ago. Poles continue to be a critical infrastructure component for modern telecommunications and electric service delivery. Although twenty-first-century communications utilize fiber optic cable and wireless broadband to carry video, voice, and data, many of the components in these modern digital networks are now and will continue to be located on poles in distribution systems.

Utility structures, such as utility poles, attachments and connected spans of utility poles must regularly be analyzed and surveyed for a variety of purposes, including loading assessments (e.g. identification and determination of placement of various attachments on structure), joint-use attachment surveys (e.g. determining spacing of attachments and structures), foliage management, and the like. Such analyses and surveys are time- and labor-intensive, and consequently expensive. Pole surveys, including the determination of pole heights, spacing and attachment heights and spacing involve field surveys by engineers who manually make necessary measurements. Additionally, obtaining some measurements, such as wire diameters, requires an exchange of information between separate electric and telecommunications companies, resulting in extra delays and costs.

Although remote-sensing technology, such as LiDAR (Light Detection and Ranging) may be useful for determining the distance to, or other properties of, a target by illuminating the target with light, these techniques may be expensive, data intensive and ineffective in identifying various components and attachments to utility structures. A failure to identify and survey the necessary structures and attachments frequently requires additional field visits, engineering resources and costs.

New methods of conducting analyses and detailed surveys of utility structures using remotely collected data that reduces the manual measurement of utility structures by engineers and provides more accurate determination of utility structures that reduces redeployment of engineering resources are needed and provided by the present invention.

### Field Surveys of Utility Structures

Before new cable or equipment may be added to in-service poles, two questions must be answered: 1) Is there enough space to safely locate the new addition? 2) Does the pole have sufficient unutilized strength to carry the additional load? Loading and clearance analysis, make-ready and replacement design, post-construction verification, pole strength upgrading, and system hardening require accurate measurements of conductor heights, diameters, and clearances using digital images that may be captured easily and quickly in the field. Field surveys assess various parameters, including grade of construction—B, C or Cx, pole length and class, span lengths, the number size and location of primary and secondary wires, determination of the total diameter of communications attachments, determinations of the size and location of streetlights, transformers and miscellaneous equipment and the number and orientation of service drops.

The accuracy of pole loading and clearance analysis calculations is dependent upon quality field data. Commonly collected data include pole identification, brand information, GPS coordinates, pole circumference, equipment information, attachment heights, high-resolution images, line angle measurements, and span lengths.

The remotely collected data may be utilized to model and analyze utility structures with available software systems which produces detailed analysis reports. The data may be used to determine whether a structure meets code requirements and whether guying changes, pole strengthening applications, or pole replacement are necessary.

Using the calibrated digital images of the present invention, detailed, accurate measurements of the existing conditions on the pole including pole tip height, attachment heights, wire diameters, equipment sizes, line angle measurements, clearance measurements, and relative measurements may be made.

The calibrated digital images of the present invention allow for measurement results to be reviewed and/or confirmed without additional visits to the field. The calibrated digital images may be used as a reference to extract measurements “as needed” from any location.

Once the structure is accurately modeled according to the existing conditions, a clearance analysis may be performed. Clearance analysis options range from checking existing conditions against the code requirements to applying all required temperature and loading conditions to determine the worst-case clearances.

Pole attachment applications may cause significant delays when installing new cables on utility poles, especially when pole loading and clearance analysis is required. Before new cable or equipment may be added to in-service poles, three questions must be answered: 1) Is there enough space to safely locate the new addition? 2) Does the pole have sufficient unutilized strength to carry the additional load? 3) What make-ready is required?

The calibration methods of the present invention allow the placement of new attachments that meet utility standards and applicable codes by identifying inadequate space or strength or supporting a denial of attachment determination, obtaining accurate measurements for conductor heights, wire diameters, and clearances.

### SUMMARY OF THE INVENTION

The present invention provides methods for calibrating a digital photographic image of one or more utility structures, comprising the steps of collecting a digitized photographic image of a utility structure, collecting low-density LiDAR data and generating sparse three-dimensional point cloud data from said low-density LiDAR data, merging the three-dimensional point cloud data with the digital photograph, and determining matrices such that each pixel of the digital photograph is associated with a coordinate obtained from the point cloud. In one embodiment, the utility structure is selected from a member of the group consisting of one or more utility poles, one or more utility pole attachments and one or more connected spans of utility poles.

In a preferred embodiment, the digitized photograph and the low-density LiDAR data are collected with a digital camera situated in a known spatial geometry relative to a LiDAR sensor. In a more preferred embodiment, the field of view of the digital camera is coaxial with the LiDAR illumination head.

In a preferred embodiment, the digital photographic image is high density. The low-density LiDAR preferably has a pulse spacing of between 0.3 and 12 pulse/m².

The present invention provides methods wherein the digitized photographic image and the low-density LiDAR data may optionally be collected simultaneously or wherein the digitized photographic image and the low-density LiDAR data are collected in a single pass by the utility structure. In one embodiment, the target structure is illuminated at some point by the LiDAR, and that the point cloud data and the LiDAR data are both available at the time the photogrammetric analysis is to be performed. Any method where a LiDAR point cloud and a digital photographic image is collected, so that the face of the structure illuminated by the LiDAR is largely the same face imaged by the camera, is suitable for the methods of the present invention. In another preferred embodiment, the collecting and merging steps occur simultaneously.

The present invention also provides methods of performing photogrammetry on a digital image comprising the step of providing a digital photograph calibrated according to the methods of the present invention.

The present invention also provides methods of performing a loading analysis on a utility structure comprising the steps of providing a digital photograph calibrated according to the methods of the invention and identifying one or more utility pole attachments on the utility structure.

The present invention also provides methods of performing a joint use attachment survey on a utility structure comprising the steps of providing a digital photograph calibrated according to the methods of invention and identifying the spacing between one or more utility pole attachments on the utility structure.

The present invention also provides methods of performing a foliage management survey on a utility structure comprising the steps of providing a digital photograph calibrated according to the methods of the invention and identifying the proximity of foliage relative to the utility structure.

### BRIEF DESCRIPTION OF THE DRAWINGS

FIG. 1 depicts the simultaneous collection of digital photographic images and low-density LIDAR data of utility structures.

### DETAILED DESCRIPTION OF INVENTION

The present invention provides methods of calibrating digital photographic images that may be used for photogrammetric assessment of utility structures. The photographic and LiDAR data may be collected remotely by single or multiple drives past one or more utility structures. This method avoids or reduces manual surveys and measurements that are currently conducted by measuring sticks and hand-held lasers. By using the digital photograph as the primary data source, the inventors have discovered that low-density LiDAR may be used to calibrate the digital photograph, which may be used in methods of performing photogrammetry, loading analyses, joint use attachment surveys and foliage management surveys on a utility structure. Digital photography provides a high density, high resolution image sufficient to capture all features of a utility structure and its attachments, without the need for highly data-intensive high-density LiDAR. Low-density LiDAR is less data intensive and provides a means for accurately calibrating the photographic pixels.

LiDAR metrics refers to the statistical measurements created from the 3D point cloud achieved from LiDAR and normally used when predicting structural variables from LiDAR data. LiDAR uses ultraviolet, visible, or near infrared light to image objects and may be used with a wide range of targets, including non-metallic objects. A narrow laser beam may be used to map physical features with very high resolution.

LiDAR allows the distance between the instrument and the scattering objects to be determined. LiDAR data may be effectively used in an application to determine information about utility structures, such as the height of a utility structure, identification of the number and position of attachments to the structure and identification and characterization of one or more connected spans of utility structures.

Low-density LiDAR data collected by a LiDAR sensor takes the form of a three-dimensional “cloud” of points measured by the LiDAR sensor, where each point is associated with a particular three-dimensional location on the x-, y-, and z-axes. Additionally, each point in the 3-D cloud measured by a LiDAR sensor is associated with an “intensity” attribute, which indicates the particular level of light reflectance at the three-dimensional location of that point. In one aspect of the present invention, the density of the LiDAR sensor may be either high- or low-density LiDAR, wherein the 3-D point cloud collected by the LiDAR sensor gives at least two returns, at least 3 returns, or at least four returns, spaced along the target. In a preferred aspect of the invention, the LiDAR returns are spaced at the top and/or middle and/or bottom of the target. In one aspect of the present invention, the LiDAR data (for example, either low-density or sparse LiDAR data or high-density LiDAR focused at various positions on the target) is sufficient to define the geometry of a utility pole.

In contrast to the 3-D point cloud collected by the LiDAR sensor, a digital photographic image collected by a digital camera consists of a two-dimensional matrix of points that correspond to image data. In some embodiments of the present invention, the LiDAR sensor and digital photographic device may be offset from one another in terms of both position and orientation. Under such circumstances, the offset between the LiDAR sensor and the digital camera or other device used to collect photographic data may be orthorectified by conventional methods and techniques to allow the data collected by each system to be accurately merged to the same location in a given coordinate system.

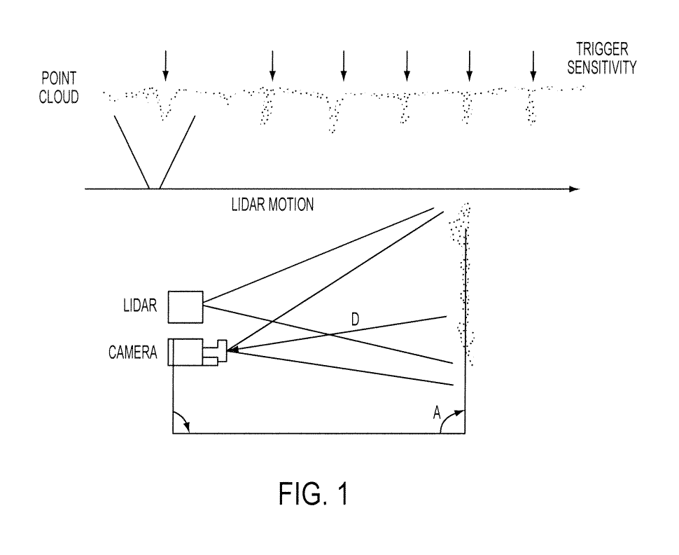

In one embodiment of the present invention, as illustrated by FIG. 1, the LiDAR sensor may be offset in a pre-determined spacial geometry from the digital camera. A threshold distance “D” from the LiDAR sensor may also be pre-determined, as may the angle “A” between the focal plane of the camera and the face of a target to be illuminated by the LiDAR sensor. The LiDAR sensor is then orthorectified with the digital camera, utilizing the predetermined distance “D,” angle “A,” and spatial geometry of the sensor and camera, before LiDAR data and digital photographic data may be obtained by the sensor and camera. This orthorectification of the digital photographic image enables the embodiment of the present invention to automatically merge photographic image data with LiDAR data simultaneously collected.

In one embodiment of the present invention, orthorectification of a LiDAR sensor with a digital camera may be performed to ensure that the 3-D point cloud data collected by the LiDAR sensor may be accurately merged with the digital photographic data collected by the digital camera. Because the LiDAR sensor and digital camera do not occupy the same physical space in this embodiment, the focal points of the LiDAR sensor and digital camera will diverge, resulting in parallax distortion. To correct for this distortion, “correction parameters,” may be determined which may be utilized to ensure that the 3-D point cloud data collected by the LiDAR sensor may be accurately merged with the digital photographic image data collected by the digital camera.

In one embodiment of the present invention, a flat vertical target surface, featuring multiple reflective “scanning targets” arranged in an equidistant orientation along the horizontal axis of the target surface, may be used to determine the orthorectified parameters for calibration of the LiDAR sensor with the digital camera. The LiDAR sensor and digital camera may be used to simultaneously collect LiDAR and digital photographic image data, respectively, at a predetermined threshold distance from the LiDAR sensor. The predetermined threshold distance may be defined in an imaging plane perpendicular to the focal axes of the digital camera and the LiDAR sensor. The collected data may be provided to a computing device containing a processor for executing and memory for storing instructions for determining the correction parameters for calibration. The computing device also features a display, allowing an operator of the computing device who is calibrating the system to view the “region of interest” (ROI) that may be simultaneously being collected by both the LiDAR sensor and the digital camera on the display.

The operator of the computing device may utilize the display of the computing device to coarsely align the physical orientation of the LiDAR sensor and the digital camera so that the ROI being collected by the LiDAR sensor and displayed on the computing device may be aligned with an identical ROI being simultaneously collected and displayed on the computing device by the digital camera. Once this coarse physical alignment has been performed so that the ROI of the LiDAR sensor is the same as the ROI of the digital camera, the LiDAR sensor and digital camera may be utilized to simultaneously capture data on each of the scanning targets at the threshold distance from the target surface.

In one embodiment of the present invention, each recorded LiDAR laser measurement may be returned from the LiDAR sensor with a precise time tag that may be converted into a range and raw scan angle from the LiDAR sensor's laser origin. This raw scan angle may be used to compute the nominal distance parallax correction parameters, as detailed below. Then, the raw range measurement may be used, along with the scan angle, to compute an across scan correction parameter based on the range to the target surface. At this point, a unique pixel location on the x- and y-axes in the digital photographic image may be determined for the LiDAR measurement that has been corrected for both x- and y-axis lens distortion/parallax, and has also been corrected for offset due to the distance to the target. This pixel location represents a modeled fit of the image data to the return LiDAR 3-D point measurement.

Data simultaneously captured by the LiDAR sensor and the digital camera may be transmitted to the computing device, which processes instructions for determining correction parameters for the calibration. In one embodiment of the present invention, the computing device employs image target recognition techniques to extract the x- and y-axis pixel location of the centroid of each scanning target from the captured digital photographic image data. The computing device also plots the return intensity of the data collected by the LiDAR sensor against the scan angle of the collected data to extract the scan angle location of peaks in the intensity of the LiDAR data. The scan angle locations of each of these “intensity peaks” correspond to the physical location of each of the reflective scanning targets.

In some embodiments of the present invention, the collection of LiDAR data and digital photographic image data for the calibration process may be repeated at multiple threshold distances from the target surfaces. In other embodiments, LiDAR and digital photographic image data may be collected at only one threshold distance.

In one embodiment of the present invention, once the collection of LiDAR and digital photographic image data for the calibration may be finished, the computing device determines the correction parameters. This determination may be performed by applying a least squares adjustment to determine the x- and y-pixel location in the digital photographic image for the collected LiDAR data corresponding to various scan angles. If calibration data has been collected at multiple threshold distances, then the least squares adjustment may be performed for multiple axes. The polynomial order of the model depends on the number of distances at which calibration data has been collected: for example, for three distances, the fit would be a linear model, but for four distances, a second order polynomial would be utilized.

In one embodiment of the present invention, a least squares adjustment may be determined by the following equations, where ⊖ is equal to the scan angle of the LiDAR, and the correction parameters A, B, C, D, F, G, and H may be solved for in a least squares adjustment to minimize the residuals in the fit of the LiDAR data to the X and Y pixels:

X_{image}=A*⊖³+B*⊖²+C*⊖+D

Y_{image}=F*⊖²+G*⊖+H

In some embodiments of the present invention, the order of the polynomial fit in each coordinate of the photographic image pixel data may be increased or decreased if additional correction parameters may be required to properly fit the collected data.

Once the fit and parallax correction parameters are determined, in one embodiment of the present invention, these parameters, along with any other parameters specific to the digital camera, may be provided to post-processing software executed on the computing device. The post-processing software applies these correction parameters to LiDAR 3-D point cloud data and the corresponding photographic image data collected in the field to ensure accurate “merging” of the 3-D point cloud data with the digital photographic image data.

In another embodiment of the present invention, a LiDAR sensor may be collocated with a digital camera in a known relative fixed geometry, and the stream of collected data from the LiDAR sensor may be recorded and monitored in real-time. When an object (e.g., a utility pole) is illuminated by the LiDAR sensor at a fixed threshold distance from the sensor, the image data being simultaneously acquired by the digital camera may be tagged. In post-processing, the 3-D point cloud data obtained by the LiDAR sensor occupying the same relative position as the object illuminated at the threshold distance may be processed and used to form a matrix describing the relationship between that object and the tagged image data. This matrix may then be used to perform photogrammetric analysis on the image data in the absence of manual calibration and without the need for stereoscopic image pairs and/or the identification of convergent points.

In various embodiments of the present invention, a variety of different devices may be used to collect image data to be fused with the collected LiDAR 3-D point cloud data, including but not limited to passive sensors, RGB line scan cameras, hyperspectral cameras, and infrared capable cameras.

In one embodiment of the present invention, once the LiDAR sensor collocated with the digital camera in a known relative fixed geometry has been calibrated, the LiDAR sensor and digital camera may be utilized to collect data on one or more utility structures in the field. In post-processing, the correction parameters determined during calibration may be utilized to perform photogrammetric analysis on the collected 3-D point cloud and photographic image data.

In some embodiments of the present invention, the photogrammetric analysis performed on the collected 3-D point cloud data and image data may extract one or more measurements of one or more utility structures from the collected data. In one embodiment of the present invention, the photogrammetric analysis may be performed by Osmose, Inc.'s Digital Management Technology™ (DMT™). These measurements are selected from the group comprising pole tip height, attachment height(s), equipment size(s), wire diameter(s), line angle measurement(s), relative measurement(s), clearance measurement(s), and span length(s).

In some embodiments of the present invention, in addition to the one or more measurements extracted through photogrammetric analysis, existing or pre-populated values may also be provided. These values are selected from the group comprising GPS data, GIS data, CIS data, and values for common poles, conductors, crossarms, overhead equipment, guys, and anchors.

In some embodiments of the present invention, the measurements extracted through photogrammetric analysis and the existing/pre-populated values may be utilized to perform a pole loading analysis.

In some embodiments of the present invention, the pole loading analysis estimates a pole load, allowing utility poles that are clearly less than fully loaded or that are clearly overloaded to be identified. The pole loading analysis may be performed by pole inspection software executing on a computing device. In one embodiment, the pole inspection software may be Osmose, Inc.'s Loadcalc® software. The pole inspection software takes into account multiple factors, including the grade of construction of a utility pole (B, C, or Cx), the pole's length and class, span lengths, the number, size of location of primary and secondary wires, the total diameter of communications attachments, the size & location of streetlights, transformers, and miscellaneous equipment, and the number & operation of service drops. The software estimates the actual load on the pole, and determines the pole strength required by the National Electric Safety Code (NESC) for that load amount.

The NESC requires that a utility pole must be removed, replaced, or restored once the pole loses ⅓rd of the original required bending strength for the load carried by that pole. In one embodiment of the present invention, a pole inspector may take the load estimated by the pole inspection software and the determined pole strength required to support that load, and compare the percent remaining strength of the utility pole to the determined required remaining strength. The pole inspector may then recommend that the utility pole pass inspection, that the pole be replaced or restored, or that a more comprehensive loading analysis be performed to validate the utility pole's compliance with the NESC requirements.

In some embodiments of the present invention, the pole loading analysis may be a comprehensive pole loading modeling and analysis. The comprehensive pole loading modeling and analysis may be performed by utility pole structural analysis software executing on a computing device. In one embodiment, the structural analysis software may be Osmose, Inc.'s O-Calc® software. The O-Calc® software incorporates the Digital Measurement Technology measurement tool to accurately extract measurements from the calibrated digital photographic data.

In some embodiments of the present invention, the utility pole structural analysis software may utilize the extracted measurements and pre-populated values to model and analyze the structural loads on new and existing utility poles. The calculations performed by the pole structural analysis software incorporate pole attributes, attachment attributes, wind and ice loads, complete guyed pole analysis, thermal loads on cables and conductors, pertinent codes and custom load cases, dynamic wire tension loads, and existing conditions (e.g., leaning poles).

In some embodiments of the present invention, the utility pole structural analysis produces one or more calculations on pole loading, dynamic sag and tension, worst-case sag and tension, and/or strength reduction. The results of these calculations may be presented in a report, a chart, a 2-D pole configuration model, a 3-D pole configuration model, a graph, and/or a data summary.

In one embodiment of the present invention, the utility pole structural analysis software may be utilized to perform a clearance analysis. Clearance analysis options range from checking existing conditions against the code requirements to applying all required temperature and loading conditions to determine the worst-case clearances. An engineering technician or other qualified personnel may suggest adjustments to correct any violation.

In one embodiment of the present invention, an engineering technician or other qualified personnel may determine an appropriate action to take if the structural analysis software indicates that a utility pole fails to meet code requirements. The appropriate action to be taken by the technician is selected from the group comprising guying changes, pole strengthening applications, and pole replacement design.

In one embodiment of the present invention, the utility pole structural analysis software may be utilized to perform a joint use attachment survey. Field technicians may document the presence of attachments on a structure as well as the ownership of the attachments and whether or not guys and anchors are shared. The “as built” condition of utility structures may be verified, and WMS and GIS updated. To ensure code compliance and reduce liability, safety risks and code violations may be identified.

We claim:

1. A method of calibrating a digital photographic image of one or more utility structures, comprising the steps of
a) collecting a digitized photographic image of a utility structure,
b) collecting low-density LiDAR data and generating sparse three-dimensional point cloud data from said low-density LiDAR data,
c) merging the three-dimensional point cloud data with the digital photograph, and
d) determining matrices such that each pixel of the digital photograph is associated with a coordinate obtained from the point cloud.

2. The method of claim 1, wherein the digitized photograph and the low-density LiDAR data are collected with a digital camera situated in a known spatial geometry relative to a LiDAR sensor.

3. The method of claim 1, wherein the utility structure is selected from the group consisting of one or more utility poles, one or more utility pole attachments and one or more connected spans of utility poles.

4. The method of claim 1, wherein the digital photographic image is high density.

5. The method of claim 1, wherein the low-density LiDAR has a pulse spacing of between 0.3 and 12 pulse/m².

6. The method of claim 1, wherein the digitized photographic image and the low-density LiDAR data are collected simultaneously.

7. The method of claim 1, wherein the digitized photographic image and the low-density LiDAR data are collected in a single pass by the utility structure.

8. The method of claim 1, wherein the collecting and merging steps occur simultaneously.

9. A method of performing photogrammetry on a digital image comprising the step of providing a digital photograph calibrated according to the method of claim 1.

10. The method of claim 9, wherein the photogrammetry measures one or more parameters selected from the group consisting of pole tip height, attachment height, equipment size, wire diameter, line angle, clearance distance and span length.

11. A method of performing a loading analysis on a utility structure comprising the steps of providing a digital photograph calibrated according to the method of claim 1 and identifying one or more utility pole attachments on the utility structure.

12. A method of performing a joint use attachment survey on a utility structure comprising the steps of providing a digital photograph calibrated according to the method of claim 1 and identifying the spacing between one or more utility pole attachments on the utility structure.

13. A method of performing a clearance analysis on a utility structure comprising the steps of providing a digital photograph calibrated according to the method of claim 1 and identifying the proximity of structures or objects relative to the utility structure.

14. The method of claim 13, further comprising the step of performing a guying change on the utility structure.

15. The method of claim 13, further comprising the step of strengthening the utility structure.

16. The method of claim 13, further comprising the step of replacing the utility structure.

17. The method of claim 13, further comprising the step of designing a utility structure replacement.
